(19) United States
(12) Patent Application Publication
(10) Pub. No.: US 2008/0313370 A1
(43) Pub. Date: Dec. 18, 2008

(54) Guarding Method For Input Data By Usb Keyboard and Guarding System

(76) Inventors: Hong Suk Kang, Seoul (KR); Hang Bae Chang, Seoul (KR)

Correspondence Address: IPLA P.A., 3580 WILSHIRE BLVD., 17TH FLOOR, LOS ANGELES, CA, 90010, US

(21) Appl. No.: 12/094,577

(22) PCT Filed: Nov. 24, 2005
(86) PCT No.: PCT/KR05/03975

§ 371 Date: May 21, 2008

(51) Int. Cl. G06F 13/38

(52) U.S. Cl. 710/67

(57) ABSTRACT

The present invention relates generally to a security system and a security method using the same, and, more particularly, to a security system and method for a keyboard which communicates through a USB port. The security method includes the USB filter activation step; the input data reception step of initially receiving the data input through the USB keyboard by the USB filter; the key input information detection step of detecting key input information generated by key manipulation of a user from the input data; the key input information parsing step of arranging the detected key input information in generation order; the key input information encryption step of encrypting the key input information arranged at the parsing step; the input data deletion step of deleting the input data remaining in a USB bus to disallow an operating system to recognize the input data; and the key input information delivery step of delivering the encrypted key input information to a communication application.

### TECHNICAL FIELD

The present invention relates generally to a security system and a security method using the same, and, more particularly, to a security system and method for a keyboard which communicates through a USB port.

### BACKGROUND ART

As financial transactions, such as banking or securities business, and the communication of data, including email and confidential affairs, conducted via the Internet, increases, a case frequently occurs in which personal information or secret information is intercepted for a malicious purpose by circumventing the communication security of the Internet.

Generally, the above-described information leakage is carried out through various spyware or hacking programs, most of which employ a method of separately intercepting data input through an input device, such as a keyboard, and then transmitting the data to an appointed email address or website address.

As a result, in order to prevent information leakage, a conventional method is to detect and delete spyware or a hacking program (hereinafter referred to as a malicious program) installed in a computer. That is, the conventional method installs a vaccine or spyware prevention program (hereinafter referred to as a security program) for detecting and deleting malicious programs from a computer, thereby preventing the activation of malicious programs and, if possible, completely deleting them from the computer.

However, the above-described conventional method has limitation in applications for newly created or discovered malicious programs, and there is an inconvenience of periodically receiving a software patch and updating a malicious program list to provide against new malicious programs.

Thereafter, technologies of fundamentally preventing the activation of malicious programs while decreasing the above-described inconvenience have been developed, and a representative technology is a security system and method associated with security for a keyboard.

A conventional keyboard uses a PS/2 method and generates physical electrical signals by keyboard manipulation. The electric signals are received by an operating system, and corresponding interrupt routines are separately processed using their respective queues (FIFO; First In, First Out).

Currently, as the communication between the main body and peripheral devices of a computer is performed through the flow of packets including several pieces of data rather than the simple flow of electric signals, unlike with the PS/2 method, a USB-type keyboard, which is connected with an operating system through the exchange of messages, has been developed. Such demand for a USB keyboard rapidly increases according to the tendency in which conventional desktop computers are becoming more compact, and so the attachment and detachment of peripheral devices are easier. That is, the USB keyboard has advantages in that it can be directly connected to the USB port of the main body of a computer and the inconvenience of rebooting immediately after connection decreases, unlike a PS/2 type keyboard.

However, a system and method for resolving security problems for the current USB-type keyboard have not yet been suggested. As a result, problems occur in that there is no provision against information leakage due to malicious programs, which is conducted at a lower USB-type keyboard level.

### DISCLOSURE OF INVENTION

### Technical Problem

Accordingly, the present invention has been made keeping in mind the above problems occurring in the prior art, and an object of the present invention is to provide a security method for data input through a USB keyboard which prevents information input through a keyboard, which communicates with the main body of a computer through a USB port, and transmits data, from being leaked to the outside due to a malicious program.

### Technical Solution

In order to accomplish the above object, the present invention provides a security method for data input through a USB keyboard, including the USB filter activation step; the input data reception step of initially receiving the data input through the USB keyboard by the USB filter; the key input information detection step of detecting key input information generated by key manipulation of a user from the input data; the key input information parsing step of arranging the detected key input information in generation order; the key input information encryption step of encrypting the key input information arranged at the parsing step; the input data deletion step of deleting the input data remaining in a USB bus to disallow an operating system to recognize the input data; and the key input information delivery step of delivering the encrypted key input information to a communication application.

Furthermore, in order to accomplish the above object, the security method according to the present invention further includes the USB filter installation determination step of determining installation of a USB filter corresponding to the USB keyboard when it is determined that a hardware ID of the USB keyboard has not been registered at the USB keyboard examination step; and the filter installation step of installing the USB filter for securing key input information of the new USB keyboard. Furthermore, in order to accomplish the above object, in the security method, the filter installation step includes the HID device searching step of searching for hardware IDs of HID devices registered in a registry of the operating system; the keyboard searching step of searching for the hardware IDs classified as keyboards from the hardware IDs; the USB device searching step of searching for hardware IDs of the USB devices registered in the registry of the operating system; the matching ID identification step of identifying matching hardware IDs from hardware IDs searched through the keyboard searching step and the USB device searching step; and the filter registration step of registering the USB filters in a device registry of the hardware IDs identified at the matching ID identification step.

Meanwhile, in order to accomplish the above object, the present invention provides a security system for data input through a USB keyboard, including a USB keyboard, the USB keyboard including a key input information detection module for detecting key input information about keys from input data generated by manipulation of the keys; a parsing module for arranging the key input information in generation order; an encryption module for encrypting the arranged key input information; and an input data deletion module for processing the input data so as to disallow an operating system to recognize the input data.

Furthermore, in order to accomplish the above object, the security system according to the present invention further includes a USB controller including a management module for interfacing communication between a plurality of USB filters and the operating system.

Furthermore, in order to accomplish the above object, in the security system, the USB controller includes a filter examination module for determining whether a new USB keyboard has been installed by counting hardware IDs of USB keyboards connected to a computer main body and USB filters corresponding to them; and a filter installation module for installing a USB filter corresponding to the new USB keyboard.

### BRIEF DESCRIPTION OF THE DRAWINGS

FIG. 1 is a block diagram illustrating the construction of a security system according to the present invention;

FIG. 2 is a block diagram illustrating the construction of the filter and controller of the security system according to the present invention;

FIG. 3 is a flowchart illustrating an embodiment of a security method according the present invention;

FIG. 4 is a flowchart illustrating another embodiment of a security method according the present invention; and

FIG. 5 is a flowchart illustrating an embodiment of a method of installing the filter according the present invention.

### MODE FOR THE INVENTION

The present invention is described in detail with reference to the accompanying exemplary drawings.

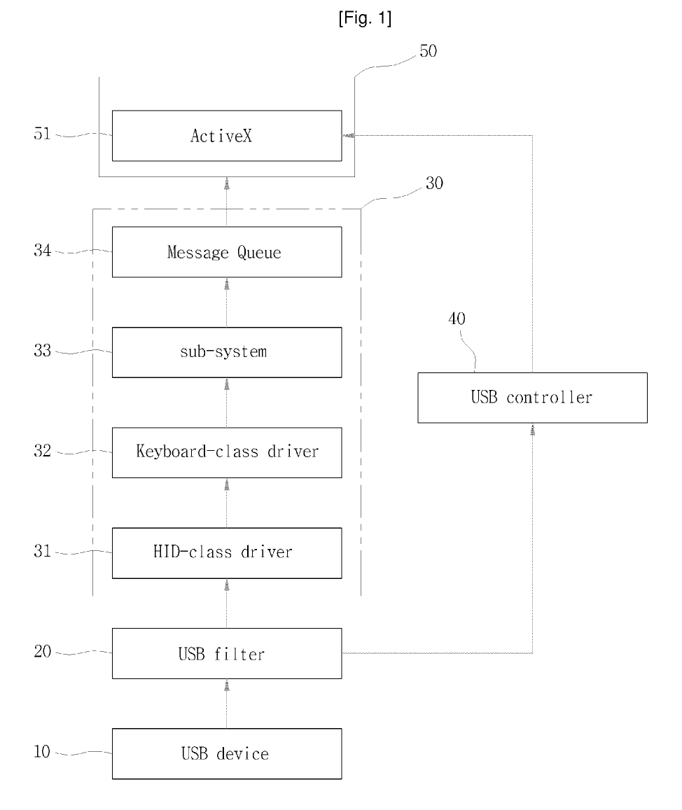

FIG. 1 is a block diagram illustrating the construction of a security system according to the present invention.

The security system according to the present invention includes a USB filter 20 and a USB controller 40 for managing it.

As illustrated in FIG. 1, the USB filter 20 is systematically arranged such that the USB cable of a USB keyboard is preferentially connected to a USB device 10 including USB hardware (not shown) having a USB port physically connected to a computer main body, a host controller driver (usbport.sys), and a USB hub driver (usbhub.sys). The arranged USB filter 20 initially detects the input data of a USB keyboard before an operating system 30 detects the data of the USB keyboard input through the USB device 10.

In the case where the USB filter 20 has not been installed or activated, the processing procedure of an operating system 30 for the data input from the USB keyboard is as follows.

First, the data input to the USB device 10 is transmitted to the HID-class driver 31 of the operating system. The term “HID” is the acronym for “Human Input Device”, and refers to a device for allowing humans to manually input data as it literally means. That is, the HID includes a keyboard, a mouse, a joystick, etc.

The input data transmitted to the HID-class driver 31 includes input data having information about an input device generating the input data, that is, the keyboard, through which the HID-class driver 31 recognizes that the input data currently received through the USB port is input data from the keyboard. For this purpose, the HID-class driver 31 includes a HID mini-driver (hidusb.sys) and a Hid-class driver (hidclass.sys), and allows the operating system 30 to recognize the data input through the USB port.

When it has been determined that the input data through the USB port is the data input through the keyboard, the operating system 30 identifies the type of the keyboard using the input data and searches for a driver for enabling the keyboard to be connected to the computer main body and to be utilized. For this purpose, the input data passed through the HID-class driver 31 is delivered to a keyboard-class driver 32.

In this case, the driver for the keyboard, which generates the input data, is searched for and driven, thereby allowing the keyboard to be utilized.

At this time, if the keyboard is a new keyboard which have not previously been connected to the computer main body, a user is requested to install a driver for the keyboard or the operating system 30 installs independently a required driver so as to allow the keyboard to be utilized.

For this purpose, the keyboard-class driver 32 includes a Keyboard HID mapper driver (Kbdhid.sys), and a Keyboard-class driver (kbdclass.sys), and causes the operating system 30 to identify the type of the keyboard that generates data input through the USB port.

After the content of the input data has been examined, key input information, which is generated by manipulation of the keys of the keyboard according to the user's intention and is included in the input data, is delivered to the sub-system 33 of the operating system 30 and converted into a form capable of communicating with an application 50. In general, in the case of an operating system, such as Windows, the key input information is converted into a Windows message form. In this case, the sub-system 33 may be a Win32 subsystem in the case of a Windows system.

The Windows message is delivered to an application program using a queuing method through a message queue 34. As described above, in the queue, initially input data is initially processed. The queue is applied in common to the processing of the key input information of a keyboard and various other input devices in which, upon manipulation of keys by the user, an initial manipulation must be initially processed. Meanwhile, the message queue 34 is a means for processing Windows messages delivered from a sub-system 33 using a queuing method.

The Windows messages are delivered to the application 50 through the message queue 34. Then the key input information is processed by its own function of the application 50. At this time, the application 50 may be a browser that enables communication with a web server. Especially, the application 50 may be a communication application, such as an ActiveX 51, that is separately driven through a general web browser in order for a banking server to provide services to clients upon financial transaction through the Internet.

When the flow is more technically described, the electrical data of the USB hardware, which has passed through the host controller driver, is converted into USB Request Blocks (URBs) form in a USB hub and into the form of an I/O Request Packet (IRP) in the HID-class driver 31 and the keyboard-class driver 32, and is then delivered to the sub-system 33. In the sub-system 33, it is again converted into the Windows message form and then delivered to the application 55.

Meanwhile, the security system according to the present invention preferentially receives URB (input data) from the USB device 10, performs encryption on the URB, and delivers the USB to the application 50, so that the above-described delivery process is not carried out. That is, the key input information input through the USB keyboard is directly delivered to a web server directly connected thereto through the ActiveX 51. As a result, the operating system 30 may not recognize the key input information input through the USB keyboard. However, in order for a user to visually confirm content input by himself or herself through the keyboard, the key input information passing through the security system of the present invention can be locally viewed on an output device (a monitor, etc.) in the form of text. For this purpose, encrypted key input information may be decoded by an application other than the ActiveX 51, and then be output. However, since the present invention has been made to prevent information input through a USB keyboard from leaking by hacking or a malicious program when the information is transmitted to another web server through a browser/ActiveX, procedures locally conducted are not described in this specification.

Since the operating system 30 cannot directly control the USB filter 20, the USB controller 40 is a structure required for interface between the operating system 30 and the USB filter 20, which is described in detail below.

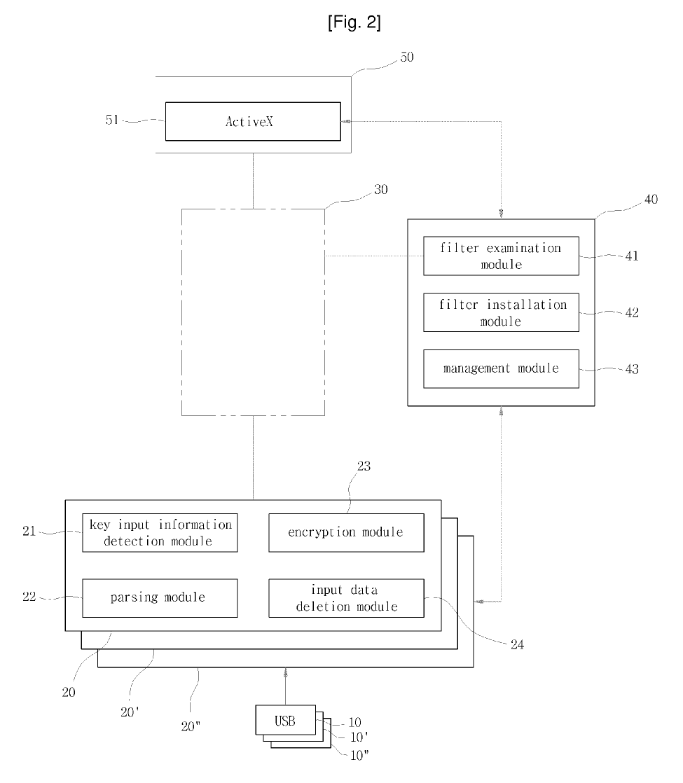

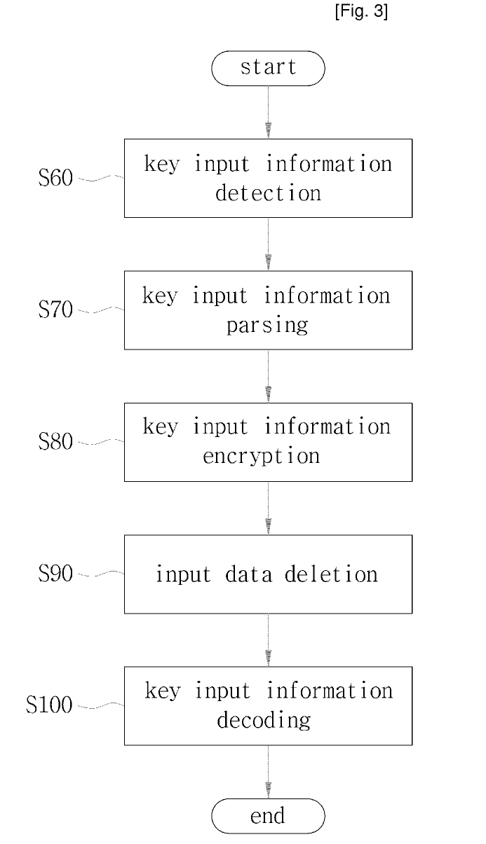

FIG. 2 is a block diagram illustrating the construction of the filter and controller of the security system according to the present invention, and FIG. 3 is a flowchart illustrating an embodiment of a security method according to the present invention. The security system and the security method using the security system are described together with reference to FIGS. 2 and 3.

In the security system according to the present invention, the USB filter 20 includes, on a USB keyboard connected to the computer main body operated by the operating system 30, a key input information detection module 21 for detecting key input information from input data generated by the manipulation of keys; a parsing module 22 for arranging the key input information in generation order; an encryption module 23 for encrypting the key input information in the form of packets and transmitting them to the activated ActiveX 51 for communication with another web server; and an input data deletion module 24 for disallowing the operating system 30 to recognize the input data.

As described above, the USB filter 20 preferentially catches and encrypts input data (key input information) delivered from the USB device 10 to the operating system 30, and then deletes the input data remaining in the USB device 10, thereby disallowing the operating system 30 to recognize data input through a USB keyboard. Therefore, there can be prevented possible collision that may be occur when the input data (key input information) encrypted by the USB filter 20 is delivered to the ActiveX 51, and, at the same time, the operating system 30 also recognizes the input data (key input information), processes it in the above-described process, and delivers it to the ActiveX 51.

Descriptions of the respective modules of the USB filter 20 are made along with a description of a security method below.

In a security system for securing the key input information of a USB keyboard through the USB filter 20,

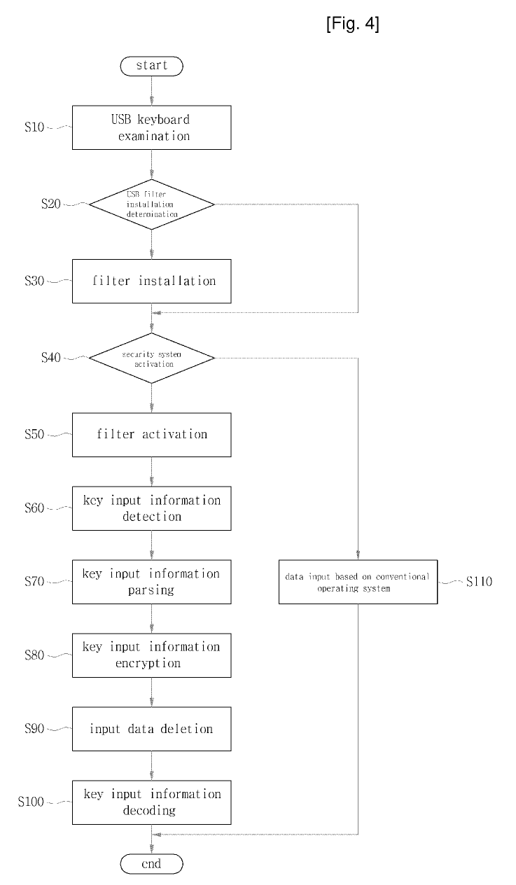

(1) USB keyboard examination step S10 (see FIG. 4) of examining whether the USB keyboard has been registered in a registry using the input data of the USB keyboard;

Electrical data, which is generated when a user manipulates the respective keys of the USB keyboard, is modified into data having a form which can be recognized by the operating system through the USB device 10. The modified data refers is referred to as input data. The input data includes information about a corresponding USB keyboard as well as key input information including content substantially intended by the user based on the manipulation of the keys. As a result, the operating system 30 searches for a driver enabling the USB keyboard to be utilized under the operating system 30 and installs the driver or requests the installation of the driver, thereby performing setting such that the user can deliver the user's intention to the operating system 30 and the application 50 through the USB keyboard.

This is described in detail below. When the cable of the USB keyboard is connected to the USB port of the computer main body, the operating system 30 exchanges signals with the USB keyboard through the cable in order to conform this. Through the signal exchange, initial input data having the information about the USB keyboard is delivered to the operating system 30, and then the operating system 30 identifies the type of the USB keyboard and installs a driver required for the utilization of the USB keyboard.

At this time, the meanings of the initial input data and the input data are definitely defined.

The initial input data is data acquired by the operating system 30 from peripheral devices when the operating system 30 actively exchanges signals with the peripheral devices in order to detect the peripheral devices connected to USB ports via cables. The input data has the key input information generated when the user manipulates the keys of the USB keyboard, and additional data configured to allow the operating system to recognize the source of the key input data.

Generally, when a peripheral device is newly connected to the computer main body, the operating system 30 installs a driver for the utilization of the peripheral device, and assigns a recognizable hardware ID to the peripheral device and registers it in a registry.

As illustrated in FIG. 2, a plurality of USB filters 20, 20′ and 20″ may be installed, and each of the USB filters 20, 20′ and 20″ is associated with a corresponding USB keyboard and prepares the security of the key input information at examination step S10.

Meanwhile, USB keyboard examination step S10 is not a step to be essentially performed, since there is no need to examine a USB keyboard when only one USB keyboard exists in the computer main body and there is no possibility for another additional USB keyboard to be installed. However, as illustrated in FIG. 2, a plurality of USB devices 10, 10′ and 10″ are provided in the computer main body, and, therefore, one or more USB keyboards are also connected to the computer main body, so that a plurality of USB filters 20, 20′ and 20″ are also formed.

That is, step S30 of examining USB keyboards is effective when a plurality of USB keyboards may be connected, and, therefore, a plurality of USB filters is installed.

(2) Key input information detection step S60 of detecting key input information from input data;

Key input information, including the content of the user's intention generated by the key manipulation of the user, that is, information about manipulated keys, is detected from the input data generated by the key manipulation of a USB keyboard by the user and delivered thereto through the key input information detection module 21. The key input information is substantially a part that must be encrypted for security. Meanwhile, a large amount of key input information is delivered at one time on a packet basis at one time according to the characteristics of the data input method of a USB keyboard.

For reference, in the case of a PS/2 type-keyboard, key input information that is generated when key manipulation is conducted is separately delivered per queue, so that a method of delivering key input information in a PS/2 type keyboard is very different from that in a USB keyboard.

(3) Key input information parsing step S70 of arranging detected key input information in the generation order of the detected key input information;

As described above, when key input information is detected from the input data by the key input information detection module 21, the information is arranged in the input order of the key input information by the parsing module 22. The arranged key input information is then transmitted to a target web server through the ActiveX 51 and processed in the input order of the key input information.

(4) Key input information encryption step S80 for encrypting the key input information arranged at the parsing step on a packet basis;

The key input information, which is arranged on a packet basis through the parsing module 22, is encrypted through the encryption module 23, thereby preventing it to be hacked or examined through a malicious program from the outside. Therefore, the key input information can be prevented from being hacked and then leaked while the key input information is delivered from the USB device 10 to the ActiveX 51 for Internet communication.

(5) Input data deletion step S90 of deleting the input data remaining in a USB bus to disallow the operating system to recognize the input data;

The operating system 30 reads the input data from the USB bus of the USB device 10 in order to examine the input data delivered from the USB device 10 to the USB keyboard. In this case, the same key input information, which is already delivered to the ActiveX 51 via the USB filter 20, collides with the input data read from the USB bus, so that errors not only occur in a system but also the input data is hacked during the delivery of the input data to the ActiveX 51 via the operating system 30, thereby causing the security function of the USB filter 20 to be useless.

As a result, the input data deletion module 23 processes the input data remaining in the USB bus and causes the operating system 30 to recognize that data input through the USB keyboard does not exist. Therefore, the data input from the USB keyboard is delivered to the ActiveX 51 only through the USB filter 20.

(6) Key input information decoding step S100

The key input information decoding step is the step of decoding the key input information encrypted on a packet basis at key input information encryption step S80, and may be performed in the ActiveX 51. Since the subsequent security procedure is performed through a separate security system in the Internet communication, the procedure is not described here.

As illustrated in FIG. 2, the number of the USB filters 20, 20′ and 20″ according to the present invention is determined depending on the number of peripheral devices connected through the USB, and a plurality of USB devices 10, 10′ and 10″ is actually provided in the computer main body to connect a plurality of USB peripheral devices to the computer main body simultaneously.

As a result, a USB controller 40 for managing a plurality of USB filters 20 must be provided for the interface between the plurality of USB filters 20 and the operating system 30.

For this purpose, in the security system according to the present invention, the USB controller 40 further includes a management module 43 for the interface/management of communication between the USB filters 20, 20′ and 20″ and the operating system 30; a filter examination module 41 for examining whether a new USB keyboard is mounted by counting the hardware IDs of the keyboards connected to a computer main board and the USB filters 20, 20′ and 20″ corresponding to the hardware IDs; and a filter installation module for installing the USB filter 20, 20′ or 20″ for the new USB keyboard.

Descriptions of the respective modules of the USB controller 40 are made, along with a description of a security method according to the present invention, with reference to FIG. 4.

FIG. 4 is a flowchart illustrating another embodiment of a security method according to the present invention.

(1) Filter activation step S50 of activating a USB filter for securing a corresponding USB keyboard searched at the USB keyboard examination step;

In the security system according to the present invention, a user can selectively determine whether to key input information input from a USB keyboard.

Since the USB filters 20, 20′ and 20″ according to the present invention operate separately from the operating system, the operating system 30 cannot control the USB filters 20, 20′ and 20″. Therefore, the USB controller 40 is provided such that a user can perform control on the USB filters 20, 20 and 20 even in the computer main body based on the operating system 30. As a result, a user utilizes the USB filters 20, 20′ and 20″ through the medium of USB controller 40, thereby determining whether to secure the key input information currently input through the USB keyboard.

Meanwhile, since the searching/selection of USB filters are unnecessary when only one USB keyboard is connected to the computer main body and, then, one USB filter according to the present invention is installed for the security of the USB keyboard, the security of the keyboard is performed through a corresponding USB filter at simultaneously with the manipulation of the USB keyboard without the identification of the USB filter. However, 127 USB ports actually exist in the computer main body, and more USB ports and a system for processing them may be implemented by adding a hub. Therefore, a plurality of USB keyboards may be connected to the computer main body, and, therefore, USB filters may be respectively installed for the USB keyboards. That is, a plurality of USB filters is installed in the computer main body.

As a result, when a plurality of USB keyboards is registered in the operating system, the step of searching for and activating a USB filter for performing security on a USB keyboard may be required at the time of connection of the USB keyboard.

Meanwhile, as at step “S40” of FIG. 4, a user can select the activation of the security system of the present invention. That is, when the activation is approved, the security of a USB keyboard is performed through the above-described security method. When the activation is not approved, the input of data by the conventional operating system 30 is performed. The subject of the approval of the activation may be a user or the security system according to the present invention.

Continuously, a method for installing new USB filters 20, 20′ and 20″ corresponding to new USB keyboards is described.

(1) USB filter installation determination step S20 of identifying a hardware ID and a USB filter corresponding to it and determining whether to additionally install a USB filter when a new USB keyboard, to which a hardware ID is not yet assigned, is connected;

As described above, the USB filters according to the present invention are respectively installed in the USB keyboards connected to the computer main body. Therefore, when a driver has been already installed and a USB filter to be associated for the security of a corresponding USB keyboard exists, the input data examination step S30 is performed. When a new USB keyboard is connected to the computer main body and a USB filter corresponding to the new USB keyboard is not installed, whether to install a USB filter to be associated for the security of the USB keyboard is determined.

At this time, at the examination step, a method of performing installation regardless of the user's intention and a method of determining the installation depending on the user's intention may be used.

Generally, when peripheral devices are connected to the computer main body, the operating system 30 assigns unique hardware IDs to the peripheral devices and registers them in a registry in order to identify and recognize them. As a result, the hardware IDs of USB devices, which have been connected to the computer main body and then utilized one or more times, have been registered in the registry of the operating system, so that the operating system 20 recognizes the USB device 10 again and directly utilizes it without the installation of its driver although the USB device 10 is disconnected from the computer main body and then connected again. Furthermore, when a USB keyboard having no hardware ID is newly connected to the computer main body, whether a driver capable of utilizing the USB keyboard has been installed is determined, and then the driver is installed, or whether to install the driver is inquired of the user. Thereafter, the installation of the driver is completed and then the operating system 30 assigns and registers a hardware ID for identifying the USB keyboard in the registry.

(2) Filter installation step S30 of installing a USB filter for securing the key input information of the new USB keyboard;

After searching step S10, in the newly connected USB keyboard, a USB filter according to the present invention is not installed for security, so that the USB filter is registered in the registry of the operating system corresponding to the newly registered hardware ID.

Eventually, when a USB keyboard is connected to the USB port of the computer main body, the operating system 30 examines the hardware ID and determines whether the driver has been installed while communicating with the USB keyboard, thereby determining whether the USB keyboard is a new USB keyboard or the hardware ID and the driver already exist. Furthermore, based on the determination, the filter examination module 41 counts the number of USB filters and the number of the hardware IDs of USB keyboards applied to them while working in association with the operating system 30. When the number of USB filters is smaller than the number of the hardware IDs, the filter installation module 42 searches for hardware IDs with which USB filters are not installed, and installs the USB filters in the registry corresponding to them.

However, in the HID scheme, peripheral devices managed using a PS/2 method are classified into classes (keyboard, mouse, joystick, etc.), whereas, in the USB scheme, peripheral devices, such as a keyboard, a mouse, a joystick and memory, are integrally registered and managed without detailed classification, such as the classes of the HID classification step, so that there is difficulty in finding out installation locations that allow the USB filters to be associated only with corresponding USB keyboards.

In the security method according the present invention, filter installation step S30 has been devised in order to resolve the problem without the modification of the operating system 30, which is described below in detail with reference to the drawings.

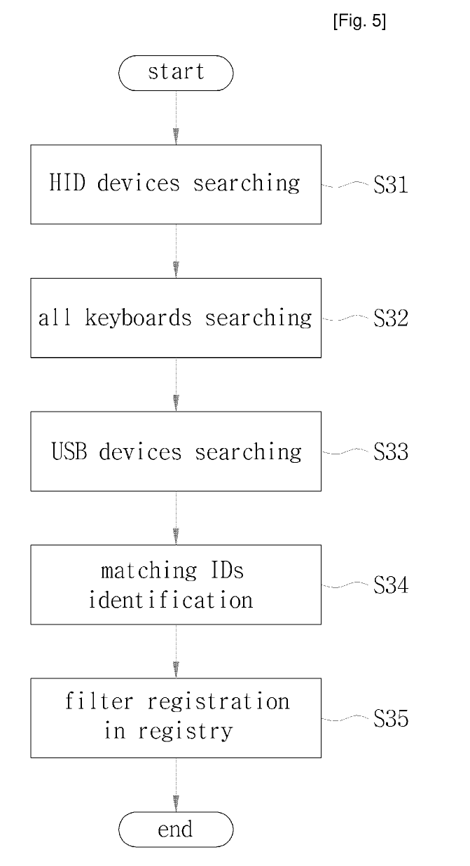

FIG. 5 is a flowchart illustrating an embodiment of a filter installation method according to the present invention.

Filter installation step S30 includes the following steps.

(1) HID device searching step S31 of searching for the hardware ID of a HID device registered in the registry of an operating system;

The filter installation module 42 searches for, through registry access API, all of the hardware IDs of peripheral devices corresponding to “HID” from the peripheral devices that are currently being used or have previously been installed in a system. In this case, when the operating system 30 is based on the Windows, SetUpDiGetClassDevs Win32 API can be used as the registry access API.

(2) Keyboard searching step S32 of searching for hardware IDs classified as keyboards from the hardware IDs;

Hardware IDs for peripheral devices, the Class Guide of which is classified as a keyboard, are searched for from the hardware IDs searched at HID device searching step S31.

(3) USB device searching step S33 of searching for the hardware IDs of USB devices registered in the registry of the operating system;

The filter installation step 42 searches for, through registry access API, all of the hardware IDs of peripheral devices corresponding to “USB” from the peripheral devices that are currently being used or have previously been installed in a system. At this time, when the operating system is based on the Windows, SetUpDiGetClassDevs Win32 API can be used as the registry access API.

(4) Matching ID identification step S34 of identifying matching hardware IDs from the hardware IDs searched at the keyboard searching step and the USB device searching step;

The keyboard-related hardware IDs and the USB-related hardware IDs searched through the above-described steps are compared with each other, and thus the hardware IDs identical to each other are searched for. Since the found hardware IDs are peripheral devices registered in the registry of the operating system in association with the USB keyboard, it is possible to access the registry of the hardware IDs in which the USB filters according to the present invention can be installed.

(5) Filter registration step S35 of registering a USB filter in the device registry of the hardware IDs searched at the matching ID searching step;

The filter installation module 42 accesses the registry of USB keyboards in which USB filters according to the present invention must be installed through the above-described steps, and, then, additionally registers the service names of the USB filters in the LowerFilters item of the registry, so that, upon the utilization of the USB keyboard, the USB filters according to the present invention initially operate, thereby performing a security function.

Meanwhile, additionally, in the embodiments of the security method according to the present invention, a corresponding peripheral device, that is, a USB keyboard, is loaded again through a “SetupDiCallClassInstaller” function, so that the USB filter can be operated along with the USB keyboard.

### INDUSTRIAL APPLICABILITY

According to the above-described present invention, data input from a USB keyboard is caught and encrypted before recognization by an operating system, and then the data is allowed to be safely transmitted to another web server without information leakage, so that information leakage due to illegal hacking conducted at a lower level can be prevented.

1. A security method for data input through a USB keyboard, comprising:
the USB filter activation step;
the input data reception step of initially receiving the data input through the USB keyboard by the USB filter;
the key input information detection step of detecting key input information generated by key manipulation of a user from the input data;
the key input information parsing step of arranging the detected key input information in generation order;
the key input information encryption step of encrypting the key input information arranged at the parsing step;
the input data deletion step of deleting the input data remaining in a USB bus to disallow an operating system to recognize the input data; and
the key input information delivery step of delivering the encrypted key input information to a communication application.

2. The security method as set forth in claim 1, wherein the USB filter activation step comprises:
the USB keyboard examination step of examining registration of a USB keyboard in a registry through initial input data of the USB keyboard; and
the filter activation step of activating a USB filter according to the registry corresponding to the USB keyboard examined at the USB keyboard examination step.

3. The security method as set forth in claim 1, further comprising:
the USB filter installation determination step of determining installation of a USB filter corresponding to the USB keyboard when it is determined that a hardware ID of the USB keyboard has not been registered at the USB keyboard examination step; and
the filter installation step of installing the USB filter for securing key input information of the new USB keyboard.

4. The security method as set forth in claim 3, wherein the filter installation step comprises:
the HID device searching step of searching for hardware IDs of HID devices registered in a registry of the operating system;
the keyboard searching step of searching for the hardware IDs classified as keyboards from the hardware IDs;
the USB device searching step of searching for hardware IDs of the USB devices registered in the registry of the operating system;
the matching ID identification step of identifying matching hardware IDs from hardware IDs searched through the keyboard searching step and the USB device searching step; and
the filter registration step of registering the USB filters in a device registry of the hardware IDs identified at the matching ID identification step.

5. A security system for data input through a USB keyboard, comprising a USB keyboard, the USB keyboard comprising:
a key input information detection module for detecting key input information about keys from input data generated by manipulation of the keys;
a parsing module for arranging the key input information in generation order;
an encryption module for encrypting the arranged key input information; and
an input data deletion module for processing the input data so as to disallow an operating system to recognize the input data.

6. The security system as set forth in claim 5, further comprising a USB controller including a management module for interfacing communication between a plurality of USB filters and the operating system.

7. The security system as set forth in claim 6, wherein the USB controller comprises:
a filter examination module for determining whether a new USB keyboard has been installed by counting hardware IDs of USB keyboards connected to a computer main body and USB filters corresponding to them; and
a filter installation module for installing a USB filter corresponding to the new USB keyboard.

8. The security method as set forth claim 2, further comprising:
the USB filter installation determination step of determining installation of a USB filter corresponding to the USB keyboard when it is determined that a hardware ID of the USB keyboard has not been registered at the USB keyboard examination step; and
the filter installation step of installing the USB filter for securing key input information of the new USB keyboard.

9. The security method as set forth in claim 8, wherein the filter installation step comprises:
the HID device searching step of searching for hardware IDs of HID devices registered in a registry of the operating system;
the keyboard searching step of searching for the hardware IDs classified as keyboards from the hardware IDs;
the USB device searching step of searching for hardware IDs of the USB devices registered in the registry of the operating system;
the matching ID identification step of identifying matching hardware IDs from hardware IDs searched through the keyboard searching step and the USB device searching step; and
the filter registration step of registering the USB filters in a device registry of the hardware IDs identified at the matching ID identification step.
